(19) United States
(12) Patent Application Publication
(10) Pub. No.: US 2022/0307894 A1
(43) Pub. Date: Sep. 29, 2022

(54) WEIGHING CHAIR

(71) Applicants: RAYFIELD CRAWFORD, Gwynn Oak, MD (US); ANNAMARIE CRAWFORD, Gwynn Oak, MD (US)

(72) Inventors: RAYFIELD CRAWFORD, Gwynn Oak, MD (US); ANNAMARIE CRAWFORD, Gwynn Oak, MD (US)

(21) Appl. No.: 17/209,329

(22) Filed: Mar. 23, 2021

(51) Int. Cl. G01G 19/52; G01G 19/44

(52) U.S. Cl. CPC G01G 19/52; G01G 19/44

(57) ABSTRACT

The weighing chair is a measurement device. The weighing chair is adapted for use with a patient. The weighing chair measures the weight of the patient as the patient is sitting in the weighing chair. The weighing chair comprises a chair structure and a measurement structure. The measurement structure attaches to the chair structure. The patient sits in the chair structure. The measurement structure measures the weight of the patient while the patient is sitting in the chair structure. The span of the length of the chair structure as measured parallel to the coronal direction is adjustable.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of physics and measuring including weighing apparatus, more specifically, a weighing apparatus or methods adapted for special purposes not provided for in the preceding groups for weighing persons. (G01G19/44)

### SUMMARY OF INVENTION

The weighing chair is a measurement device. The weighing chair is adapted for use with a patient. The weighing chair measures the weight of the patient as the patient is sitting in the weighing chair. The weighing chair comprises a chair structure and a measurement structure. The measurement structure attaches to the chair structure. The patient sits in the chair structure. The measurement structure measures the weight of the patient while the patient is sitting in the chair structure. The span of the length of the chair structure as measured parallel to the coronal direction is adjustable.

These together with additional objects, features and advantages of the weighing chair will be readily apparent to those of ordinary skill in the art upon reading the following detailed description of the presently preferred, but nonetheless illustrative, embodiments when taken in conjunction with the accompanying drawings.

In this respect, before explaining the current embodiments of the weighing chair in detail, it is to be understood that the weighing chair is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the weighing chair.

It is therefore important that the claims be regarded as including such equivalent construction insofar as they do not depart from the spirit and scope of the weighing chair. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a perspective view of an embodiment of the disclosure.

FIG. 2 is a side view of an embodiment of the disclosure.

FIG. 3 is a rear view of an embodiment of the disclosure.

FIG. 4 is a front view of an embodiment of the disclosure.

FIG. 5 is an in-use view of an embodiment of the disclosure.

FIG. 6 is a front view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

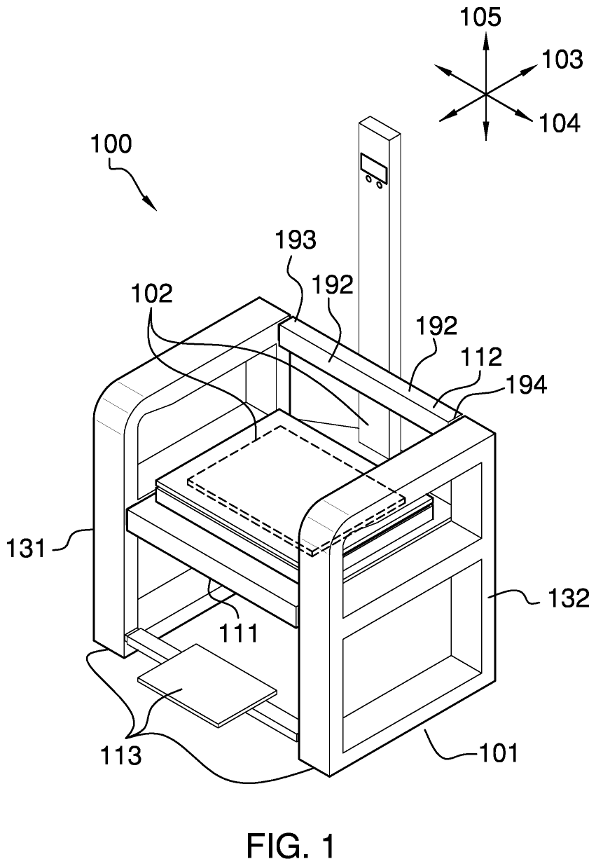

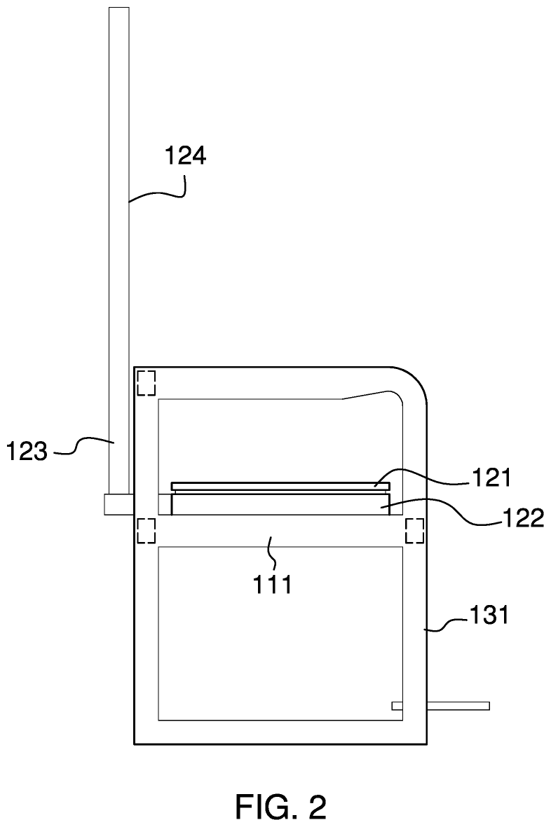

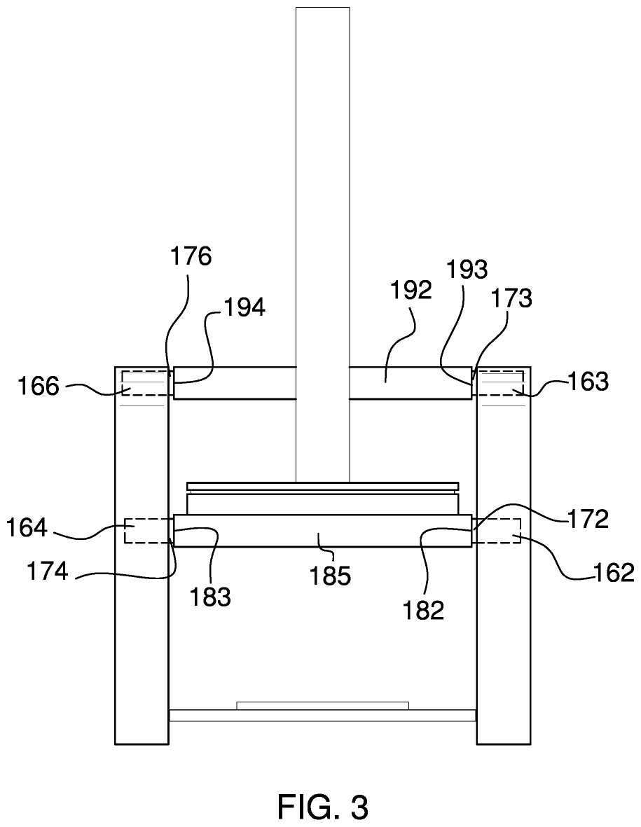

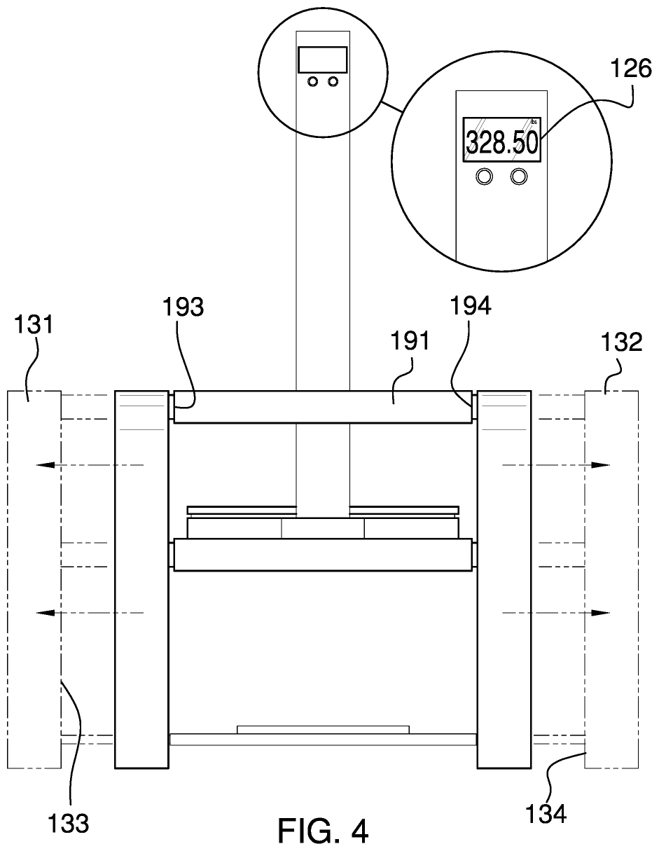

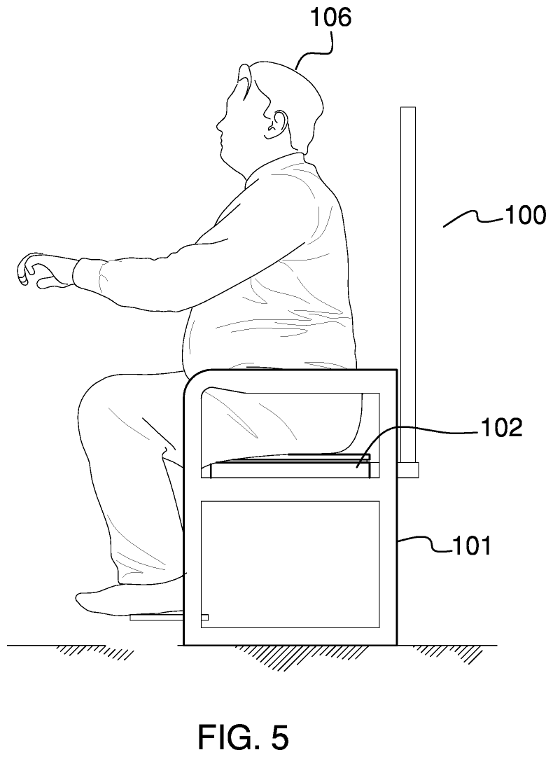

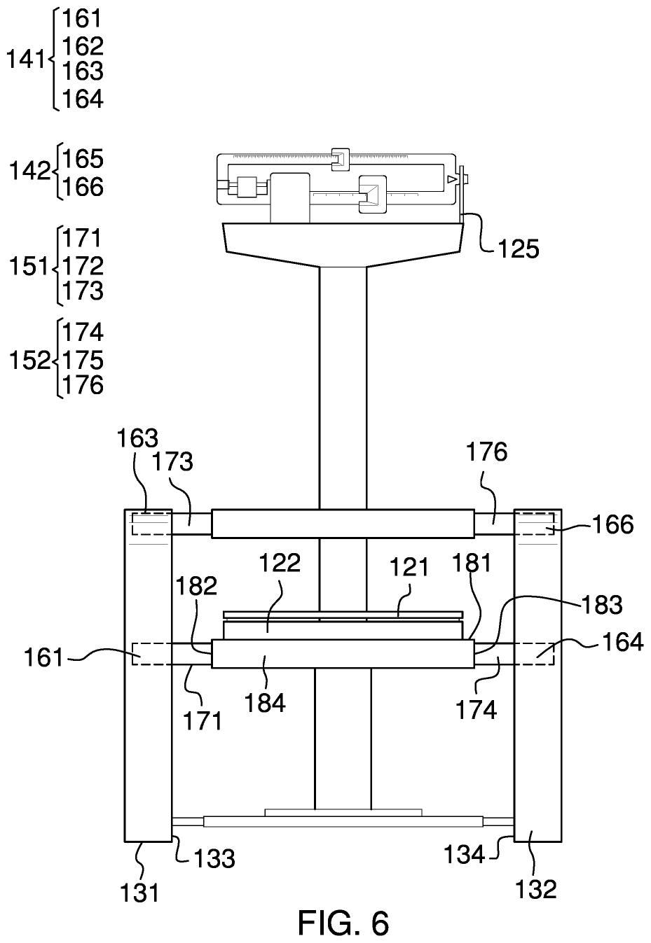

Detailed reference will now be made to one or more potential embodiments of the disclosure, which are illustrated in FIGS. 1 through 6.

The weighing chair 100 (hereinafter invention) is a measurement device. The invention 100 is adapted for use with a patient 106. The invention 100 measures the weight of the patient 106 as the patient 106 is sitting in the invention 100. The invention 100 comprises a chair structure 101 and a measurement structure 102. The measurement structure 102 attaches to the chair structure 101. The patient 106 sits in the chair structure 101. The measurement structure 102 measures the weight of the patient 106 while the patient 106 is sitting in the chair structure 101. The span of the length of the chair structure 101 as measured parallel to the coronal direction 104 is adjustable. The patient 106 is defined elsewhere in this disclosure.

The chair structure 101 is a furniture item known as a chair. The chair is defined elsewhere in this disclosure. The chair structure 101 is adapted for use by the patient 106. The patient 106 sits in the chair structure 101. The measurement structure 102 mounts in the chair structure 101. The measurement structure 102 measures the weight of the patient 106 while the patient 106 sits in the chair structure 101. The form factor of the chair structure 101 is adjustable. Specifically, the span of the length of the chair structure 101 in the coronal direction 104 is adjustable. The chair structure 101 comprises a bench 111, a backrest 112, and a plurality of armrests 113.

The chair structure 101 is further defined with a transverse direction 103, a coronal direction 104, and a sagittal direction 105. The transverse direction 103 is the direction that runs from the posterior of the patient 106 to the front of the patient 106 when the patient 106 is seated normally in the chair structure 101. The coronal direction 104 is the direction that runs from the right side of the patient 106 to the left side of the patient 106 when the patient 106 is seated normally in the chair structure 101. The coronal direction 104 is perpendicular to the transverse direction 103. The sagittal direction 105 is the direction that runs from the head of the patient 106 towards the feet of the patient 106 when the patient is seated normally in the chair structure 101. The sagittal direction 105 is perpendicular to the transverse direction 103. The sagittal direction 105 is perpendicular to the coronal direction 104.

The transverse direction 103 is further defined elsewhere in this disclosure. The coronal direction 104 is further defined elsewhere in this disclosure. The sagittal direction 105 is further defined elsewhere in this disclosure.

The bench 111 is a horizontal surface formed by the chair structure 101. The bench 111 forms a supporting platform that the patient 106 sits on. The bench 111 is defined elsewhere in this disclosure. The bench 111 is a disk-shaped structure. The center axis of the bench 111 is parallel to the sagittal direction 105. The bench 111 attaches to the plurality of armrests 113 such that the plurality of armrests 113 elevates the bench 111 above the surface supporting the invention 100. The bench 111 further comprises a first plurality of mortises 141. The first plurality of mortises 141 attach the bench 111 to the plurality of armrests 113. It shall be noted that one of the plurality of armrests 113 may be a footrest. The bench 111 further comprises a bench 111 superior face 181, a bench 111 right lateral face 182, a bench 111 left lateral face 183, a bench 111 anterior lateral face 184, and a bench 111 posterior lateral face 185.

The bench 111 superior face 181 is a congruent end of the disk structure of the bench 111. The bench 111 superior face 181 forms the superior surface of the bench 111. The bench 111 right lateral face 182 is the lateral face of the disk structure of the bench 111 that is on the right side of the patient 106 when the patient 106 is seated normally in the chair structure 101. The bench 111 left lateral face 183 is the lateral face of the disk structure of the bench 111 that is on the left side of the patient 106 when the patient 106 is seated normally in the chair structure 101. The bench 111 anterior lateral face 184 is the lateral face of the disk structure of the bench 111 that is on the anterior side of the patient 106 when the patient 106 is seated normally in the chair structure 101. The bench 111 anterior lateral face 184 is the lateral face of the disk structure of the bench 111 that is on the posterior side of the patient 106 when the patient 106 is seated normally in the chair structure 101.

Each of the first plurality of mortises 141 is a mortise that is formed in the bench 111. The mortise is defined elsewhere in this disclosure. Each of the first plurality of mortises 141 is formed as a prism-shaped negative space. Each of the first plurality of mortises 141 is formed in a lateral face selected from the group consisting of the bench 111 right lateral face 182 and the bench 111 left lateral face 183. Each of the first plurality of mortises 141 receives a tenon selected from the group consisting of: a) a tenon contained in the first plurality of tenons 151; and, b) a tenon contained in the second plurality of tenons 152. The received selected tenon attaches the bench 111 to the plurality of armrests 113. The first plurality of mortises 141 comprises a first mortise 161, a second mortise 162, a third mortise 163, and a fourth mortise 164.

The first mortise 161 is a mortise that is formed in the bench 111 right lateral face 182. The first mortise 161 is in an anterior position relative to the second mortise 162. The second mortise 162 is a mortise that is formed in the bench 111 right lateral face 182. The second mortise 162 is in a posterior position relative to the first mortise 161. The third mortise 163 is a mortise that is formed in the bench 111 left lateral face 183. The third mortise 163 is in an anterior position relative to the fourth mortise 164. The fourth mortise 164 is a mortise that is formed in the bench 111 left lateral face 183. The fourth mortise 164 is in a posterior position relative to the third mortise 163.

The backrest 112 is a prism-shaped structure. The center axis of the backrest 112 is parallel to the coronal direction 104. The backrest 112 forms a vertically oriented supporting structure that the patient 106 can lean against. The backrest 112 attaches to the plurality of armrests 113 such that the plurality of armrests 113 elevates the backrest 112 above the surface supporting the invention 100. The backrest 112 further comprises a second plurality of mortises 142. The second plurality of mortises 142 attach the backrest 112 to the plurality of armrests 113. The backrest 112 further comprises a backrest 112 anterior face 191, a backrest 112 posterior face 192, a backrest 112 right congruent end 193, and a backrest 112 left congruent end 194.

The backrest 112 anterior face 191 is the lateral face of the prism structure of the backrest 112 that is proximal to the patient 106 when the patient 106 is seated normally in the chair structure 101. The backrest 112 posterior face 192 is the lateral face of the prism structure of the backrest 112 that is distal from the patient 106 when the patient 106 is seated normally in the chair structure 101. The backrest 112 right congruent end 193 is the congruent end of the disk structure of the backrest 112 that is on the right side of the patient 106 when the patient 106 is seated normally in the chair structure 101. The backrest 112 left congruent end 194 is the congruent end of the disk structure of the backrest 112 that is on the left side of the patient 106 when the patient 106 is seated normally in the chair structure 101.

Each of the second plurality of mortises 142 is a mortise that is formed in the backrest 112. The mortise is defined elsewhere in this disclosure. Each of the second plurality of mortises 142 is formed as a prism-shaped negative space. Each of the second plurality of mortises 142 is formed in a congruent end selected from the group consisting of the backrest 112 right congruent end 193 and the backrest 112 left congruent end 194. Each of the second plurality of mortises 142 receives a tenon selected from the group consisting of: a) a tenon contained in the first plurality of tenons 151; and, b) a tenon contained in the second plurality of tenons 152. The received selected tenon attaches the backrest 112 to the plurality of armrests 113. The second plurality of mortises 142 comprises a fifth mortise 165 and a sixth mortise 166.

The fifth mortise 165 is a mortise that is formed in the backrest 112 right congruent end 193. The center axis of the prism structure of the fifth mortise 165 aligns with the center axis of the prism structure of the backrest 112. The sixth mortise 166 is a mortise that is formed in the backrest 112 left congruent end 194. The center axis of the prism structure of the sixth mortise 166 aligns with the center axis of the prism structure of the backrest 112.

Each of the plurality of armrests 113 is a prism-shaped structure. Each of the plurality of armrests 113 has a disk shape. Each of the plurality of armrests 113 is an irregular prism shape. The congruent ends of the disk structure of each of the plurality of armrests 113 are perpendicular to the bench 111 superior face 181. The plurality of armrests 113 forms the load path that transfers the loads of the bench 111, the backrest 112, and the measurement structure 102 to the surface supporting the invention 100. The plurality of armrests 113 elevates the bench 111 and the backrest 112 above the surface supporting the invention 100. The armrest is defined elsewhere in this disclosure.

The plurality of armrests 113 attaches to the bench 111 in a telescopic manner. The plurality of armrests 113 attaches to the backrest 112 in a telescopic manner. The telescopic structure of the plurality of armrests 113 allows for the adjustment of the span of the distance between the plurality of armrests 113 in the coronal direction 104. The adjustment of the span of the distance between the plurality of armrests 113 in the plurality of armrests 113 in the coronal direction 104 adjusts the form factor of the chair structure 101.

The plurality of armrests 113 further comprises a right armrest 131 and a left armrest 132.

The right armrest 131 is the armrest selected from the plurality of armrests 113 that supports the bench 111 and the backrest 112 from the right side of the patient 106 when the patient 106 is seated normally in the chair structure 101. The right armrest 131 attaches to the bench 111 right lateral face 182. The right armrest 131 attaches to the backrest 112 right congruent end 193. The right armrest 131 further comprises a right armrest 131 interior face 133. The right armrest 131 interior face 133 is the congruent end of the irregular disk structure of the right armrest 131 that is proximal to the patient 106 when the patient 106 is seated normally in the chair structure 101. The right armrest 131 further comprises a first plurality of tenons 151. The first plurality of tenons 151 attach the right armrest 131 to the bench 111 and the backrest 112.

Each of the first plurality of tenons 151 is a tenon. The tenon is defined elsewhere in this disclosure. Each of the first plurality of tenons 151 is a prism-shaped structure. Each of the first plurality of tenons 151 is geometrically similar to a mortise selected from the group consisting of: a) a mortise contained in the first plurality of mortises 141; and, b) a mortise contained in the second plurality of mortises 142. Each tenon selected from the first plurality of tenons 151 is sized such that the selected tenon will insert into the selected mortise. Each tenon selected from the first plurality of tenons 151 attaches to an interior face selected from the group consisting of: a) the right armrest 131 interior face 133; and, b) the left armrest 132 interior face 134. Each tenon selected from the first plurality of tenons 151 attaches to the associated selected interior face such that the center axis of the prism structure of the selected tenon projects perpendicularly away from the associated selected interior face. The first plurality of tenons 151 comprises a first tenon 171, a second tenon 172, and a third tenon 173.

The first tenon 171 is a tenon that attaches to the right armrest 131 interior face 133. The first tenon 171 is geometrically similar to the first mortise 161. The first tenon 171 is sized such that the first tenon 171 inserts into the first mortise 161 to secure the right armrest 131 interior face 133 to the bench 111 right lateral face 182. The span of the distance between the right armrest 131 and the left armrest 132 adjusts by adjusting the depth that the first tenon 171 into the first mortise 161.

The second tenon 172 is a tenon that attaches to the right armrest 131 interior face 133. The second tenon 172 is geometrically similar to the second mortise 162. The second tenon 172 is sized such that the second tenon 172 inserts into the second mortise 162 to secure the right armrest 131 interior face 133 to the bench 111 right lateral face 182. The span of the distance between the right armrest 131 and the left armrest 132 adjusts by adjusting the depth that the second tenon 172 into the second mortise 162.

The third tenon 173 is a tenon that attaches to the right armrest 131 interior face 133. The third tenon 173 is geometrically similar to the third mortise 163. The third tenon 173 is sized such that the third tenon 173 inserts into the third mortise 163 to secure the right armrest 131 interior face 133 to the backrest 112 right congruent end 193. The span of the distance between the right armrest 131 and the left armrest 132 adjusts by adjusting the depth that the third tenon 173 into the third mortise 163.

The left armrest 132 is the armrest selected from the plurality of armrests 113 that supports the bench 111 and the backrest 112 from the left side of the patient 106 when the patient 106 is seated normally in the chair structure 101. The left armrest 132 attaches to the bench 111 left lateral face 183. The left armrest 132 attaches to the backrest 112 left congruent end 194. The left armrest 132 is identical to the right armrest 131. The left armrest 132 further comprises a left armrest 132 interior face 134. The left armrest 132 interior face 134 is the congruent end of the irregular disk structure of the left armrest 132 that is proximal to the patient 106 when the patient 106 is seated normally in the chair structure 101. The left armrest 132 further comprises a second plurality of tenons 152. The second plurality of tenons 152 attach the left armrest 132 to the bench 111 and the backrest 112.

The second plurality of tenons 152 is a tenon. The tenon is defined elsewhere in this disclosure. Each of the second plurality of tenons 152 is a prism-shaped structure. Each of the second plurality of tenons 152 is geometrically similar to a mortise selected from the group consisting of: a) a mortise contained in the first plurality of mortises 141; and, b) a mortise contained in the second plurality of mortises 142. Each tenon selected from the second plurality of tenons 152 is sized such that the selected tenon will insert into the selected mortise. Each tenon selected from the second plurality of tenons 152 attaches to an interior face selected from the group consisting of: a) the right armrest 131 interior face 133; and, b) the left armrest 132 interior face 134. Each tenon selected from the second plurality of tenons 152 attaches to the associated selected interior face such that the center axis of the prism structure of the selected tenon projects perpendicularly away from the associated selected interior face. The second plurality of tenons 152 comprises a fourth tenon 174, a fifth tenon 175, and a sixth tenon 176.

The fourth tenon 174 is a tenon that attaches to the left armrest 132 interior face 134. The fourth tenon 174 is geometrically similar to the fourth mortise 164. The fourth tenon 174 is sized such that the fourth tenon 174 inserts into the fourth mortise 164 to secure the left armrest 132 interior face 134 to the bench 111 left lateral face 183. The span of the distance between the right armrest 131 and the left armrest 132 adjusts by adjusting the depth that the fourth tenon 174 into the fourth mortise 164.

The fifth tenon 175 is a tenon that attaches to the left armrest 132 interior face 134. The fifth tenon 175 is geometrically similar to the fifth mortise 165. The fifth tenon 175 is sized such that the fifth tenon 175 inserts into the fifth mortise 165 to secure the left armrest 132 interior face 134 to the bench 111 left lateral face 183. The span of the distance between the right armrest 131 and the left armrest 132 adjusts by adjusting the depth that the fifth tenon 175 into the fifth mortise 165.

The sixth tenon 176 is a tenon that attaches to the left armrest 132 interior face 134. The sixth tenon 176 is geometrically similar to the sixth mortise 166. The sixth tenon 176 is sized such that the sixth tenon 176 inserts into the sixth mortise 166 to secure the left armrest 132 interior face 134 to the backrest 112 left congruent end 194. The span of the distance between the right armrest 131 and the left armrest 132 adjusts by adjusting the depth that the sixth tenon 176 into the sixth mortise 166.

The measurement structure 102 is a measurement device. The measurement structure 102 mounts in the chair structure 101. The measurement structure 102 measures the weight of the patient 106 as the patient 106 sits in the chair structure 101. The measurement structure 102 visibly displays the measured weight of the patient 106. The measurement structure 102 comprises a sensing pad 121, a scale structure 122, and a scale stanchion 123.

The sensing pad 121 is a mechanical structure. The sensing pad 121 is a disk-shaped structure. The sensing pad 121 attaches to the bench 111 superior face 181 to form a composite prism structure. The sensing pad 121 bears the load of the patient 106 as the patient sits on the invention 100. The sensing pad 121 transfers an indication of the weight of the patient 106 to the scale structure 122. The transferred indication of the weight of the patient 106 is selected from the group consisting of: a) the load presented by the patient 106 to the sensing pad 121; or b) a measured value that indicates to the scale structure 122 the weight of the patient 106.

The scale structure 122 is a device. The scale structure 122 receives the transferred indication of the weight of the patient 106. The scale structure 122 converts the received indication of the weight of the patient 106 into a visual indication of the measured weight of the patient 106.

The scale stanchion 123 is a hollow prism-shaped structure. The center axis of the prism structure of the scale stanchion 123 is parallel to the sagittal direction 105. The hollow interior of the scale stanchion 123 contains the scale structure 122. The visual indication of the weight of the patient 106 is displayed such that the indication is visible from the exterior of the scale stanchion 123. The scale stanchion 123 further comprises a scale stanchion 123 anterior face 124.

The scale stanchion 123 anterior face 124 is the lateral face of the scale stanchion 123 that is proximal to the posterior surfaces of the patient 106 as the patient 106 sits normally in the chair structure 101. The scale stanchion 123 anterior face 124 attaches to the bench 111 posterior lateral face 185. The scale stanchion 123 anterior face 124 attaches to the backrest 112 posterior face 192. The visual indication of the weight of the scale stanchion 123 anterior face 124 is visible from the scale stanchion 123 anterior face 124. The scale stanchion 123 anterior face 124 is used as a headrest when the patient 106 is seated normally in the chair structure 101.

In the first potential embodiment of the disclosure, the scale structure 122 is selected from the group consisting of a balance scale 125 and a force sensor scale 126.

The balance scale 125 is a mechanical structure. The full weight of the patient 106 is transferred to the scale structure 122 where it is received as a load. The balance scale 125 comprises a plurality of masses that are used to generate a calibrated counter force. The balance scale 125 measures the difference between the weight of the patient 106 and the calibrated counter force generated by the scale structure 122. The balance scale 125 displays the weight of the patient 106 by displaying the calibrated counterforce when the difference between the weight of the patient 106 and the calibrated counter force equals zero.

The force sensor scale 126 is an electromechanical device. The force sensor scale 126 measures the weight of the patient 106 using a piezoelectric device. The piezoelectric sensor uses the piezoelectric effect to generate a voltage that is converted by an electric circuit into a visual display of the weight of the patient 106. The piezoelectric effect is defined elsewhere in this disclosure.

The following definitions were used in this disclosure:

Align: As used in this disclosure, align refers to an arrangement of objects that are: 1) arranged in a straight plane or line; 2) arranged to give a directional sense of a plurality of parallel planes or lines; or, 3) a first line or curve is congruent to and overlaid on a second line or curve.

Anterior: As used in this disclosure, anterior is a term that is used to refer to the front side or direction of a structure. When comparing two objects, the anterior object is the object that is closer to the front of the structure.

Armrest: As used in this disclosure, an armrest is a structure formed along a lateral side of a chair. The armrest forms a structure on which a person can place an arm.

Backrest: As used in this disclosure, a backrest is a vertical or vertically canted supporting surface formed along the posterior side of a chair. The backrest supports the back of a person sitting in the chair.

Bench: As used in this disclosure, a bench is a horizontal supporting surface formed by a chair.

Center: As used in this disclosure, a center is a point that is: 1) the point within a circle that is equidistant from all the points of the circumference; 2) the point within a regular polygon that is equidistant from all the vertices of the regular polygon; 3) the point on a line that is equidistant from the ends of the line; 4) the point, pivot, or axis around which something revolves; or, 5) the centroid or first moment of an area or structure. In cases where the appropriate definition or definitions are not obvious, the fifth option should be used in interpreting the specification.

Center Axis: As used in this disclosure, the center axis is the axis of a cylinder or a prism. The center axis of a prism is the line that joins the center point of the first congruent face of the prism to the center point of the second corresponding congruent face of the prism. The center axis of a pyramid refers to a line formed through the apex of the pyramid that is perpendicular to the base of the pyramid. When the center axes of two cylinder, prism or pyramidal structures share the same line they are said to be aligned. When the center axes of two cylinder, prism or pyramidal structures do not share the same line they are said to be offset.

Chair: As used in this disclosure, a chair is a structure that a person can sit on. The horizontal resting surface a person sits on is called the bench. Seat is a common synonym for a chair.

Composite Prism: As used in this disclosure, a composite prism refers to a structure that is formed from a plurality of structures selected from the group consisting of a prism structure and a pyramid structure. The plurality of selected structures may or may not be truncated. The plurality of prism structures are joined together such that the center axes of each of the plurality of structures are aligned. The congruent ends of any two structures selected from the group consisting of a prism structure and a pyramid structure need not be geometrically similar.

Congruent: As used in this disclosure, congruent is a term that compares a first object to a second object. Specifically, two objects are said to be congruent when: 1) they are geometrically similar; and, 2) the first object can superimpose over the second object such that the first object aligns, within manufacturing tolerances, with the second object.

Coronal Direction: As used in this disclosure, the coronal direction is a direction that runs between the lateral surfaces surface of an object and that is perpendicular to the sagittal direction and the transverse direction

Coronal Plane: As used in this disclosure, the coronal plane refers to a reference plane that bisects an anterior surface and posterior surface such that the coronal plane contains the line of the coronal direction and the line of the sagittal direction. The coronal plane is also referred to as the lateral plane. The coronal plane is perpendicular to the sagittal plane and the transverse plane.

Correspond: As used in this disclosure, the term correspond is used as a comparison between two or more objects wherein one or more properties shared by the two or more objects match, agree, or align within acceptable manufacturing tolerances.

Disk: As used in this disclosure, a disk is a prism-shaped object that is flat in appearance. The disk is formed from two congruent ends that are attached by a lateral face. The sum of the surface areas of two congruent ends of the prism-shaped object that forms the disk is greater than the surface area of the lateral face of the prism-shaped object that forms the disk. In this disclosure, the congruent ends of the prism-shaped structure that forms the disk are referred to as the faces of the disk.

Distal: As used in this disclosure, distal refers to a directional sense or location of an object. Specifically, distal refers to a first object, or a side of a first object, that is distal from the medial axis, or more proximal to the side of the object, relative to a second object, or side of a second object.

Exterior: As used in this disclosure, the exterior is used as a relational term that implies that an object is not contained within the boundary of a structure or a space.

Force of Gravity: As used in this disclosure, the force of gravity refers to a vector that indicates the direction of the pull of gravity on an object at or near the surface of the earth.

Force Sensor: As used in this disclosure, the force sensor is a sensor that generates an electrically measurable signal that is a function of the amount of force applied to the force sensor. The force sensor is often referred to as a pressure sensor. The force sensor commonly measures force using the piezoelectric effect generated by the deformation of a material.

Form Factor: As used in this disclosure, the term form factor refers to the size and shape of an object.

Geometrically Similar: As used in this disclosure, geometrically similar is a term that compares a first object to a second object wherein: 1) the sides of the first object have a one to one correspondence to the sides of the second object; 2) wherein the ratio of the length of each pair of corresponding sides are equal; 3) the angles formed by the first object have a one to one correspondence to the angles of the second object; and, 4) wherein the corresponding angles are equal. The term geometrically identical refers to a situation where the ratio of the length of each pair of corresponding sides equals 1.

Headrest: As used in this disclosure, a headrest is a vertically oriented structure that attaches to or extends from the back of a chair. The headrest is configured to cushion and support the head of a person.

Horizontal: As used in this disclosure, horizontal is a directional term that refers to a direction that is either: 1) parallel to the horizon; 2) perpendicular to the local force of gravity, or, 3) parallel to a supporting surface. In cases where the appropriate definition or definitions are not obvious, the second option should be used in interpreting the specification. Unless specifically noted in this disclosure, the horizontal direction is always perpendicular to the vertical direction.

Inferior: As used in this disclosure, the term inferior refers to a directional reference that is parallel to and in the same direction as the force of gravity when an object is positioned or used normally.

Interior: As used in this disclosure, the interior is used as a relational term that implies that an object is contained within the boundary of a structure or a space.

Lateral: As used in this disclosure, the term lateral refers to an axis of an object that is perpendicular in the horizontal plane to the primary sense of direction of the object. Lateral movement is always perpendicular to the anterior posterior axis. Lateral sides form the boundary of a coronal plane.

Lateral: As used in this disclosure, the term lateral refers to an axis of an object that is perpendicular in the sagittal and the transverse direction.

Load: As used in this disclosure, the term load refers to an object upon which a force is acting or which is otherwise absorbing energy in some fashion. Examples of a load in this sense include, but are not limited to, a mass that is being moved a distance or an electrical circuit element that draws energy. The term load is also commonly used to refer to the forces that are applied to a stationary structure.

Load Path: As used in this disclosure, a load path refers to a chain of one or more structures that transfers a load generated by a raised structure or object to a foundation, supporting surface, or the earth.

Mass: As used in this disclosure, refers to a quantity of matter within a structure. Mass is measured and quantified by the reaction of the structure to a force. Mass can also be roughly quantified as a function of atomic composition and the number of atoms contained within the structure. The term weight refers to the quantification of a mass that is exposed to the force of gravity.

Medial: As used in this disclosure, medial refers to a directional sense or location of an object. Specifically, medial refers to a first object or a side of a first object that is closer to the medial axis or more distal from the side of the object relative to a second object or side of a second object.

Medial Axis: As used in this disclosure, the medial axis is the center line of an object that is parallel to the sagittal direction. When two objects are compared relative to the medial axis, the object closer to the medial axis is referred to as the medial object and the object distal from the medial axis is referred to as the lateral object.

Negative Space: As used in this disclosure, negative space is a method of defining an object through the use of open or empty space as the definition of the object itself, or, through the use of open or empty space to describe the boundaries of an object.

One to One: When used in this disclosure, a one to one relationship means that a first element selected from a first set is in some manner connected to only one element of a second set. A one to one correspondence means that the one to one relationship exists both from the first set to the second set and from the second set to the first set. A one to one fashion means that the one to one relationship exists in only one direction.

Pan: As used in this disclosure, a pan is a hollow and prism-shaped containment structure. The pan has a single open face. The open face of the pan is often, but not always, the superior face of the pan. The open face is a surface selected from the group consisting of: a) a congruent end of the prism structure that forms the pan; and, b) a lateral face of the prism structure that forms the pan. A semi-enclosed pan refers to a pan wherein the closed end of prism structure of the pan and/or a portion of the closed lateral faces of the pan is are open.

Patient: As used in this disclosure, a patient is a person who is designated to receive a medical treatment, therapy or service. The term patient may be extended to an animal when used within the context of the animal receiving veterinary treatment or services.

Perimeter: As used in this disclosure, a perimeter is one or more curved or straight lines that bounds an enclosed area on a plane or surface. The perimeter of a circle is commonly referred to as a circumference.

Piezoelectric Effect: As used in this disclosure, the piezoelectric effect refers to a class of materials wherein a strain placed upon the material will result in a redistribution of electrons within the material in a manner that causes an electric charge. This electric charge can be measured as a voltage potential across the material. This effect can be reversed in some of these materials such that the application of an AC voltage to the material will cause a vibration within the material. A material commonly used to take advantage of the piezoelectric effect is polyvinylidene difluoride (CAS 24937-79-9) which is also known as PVDF.

Posterior: As used in this disclosure, posterior is a term that is used to refer to the side of an object that is distal or in the opposite direction of the anterior side. When comparing two items, the posterior item is the item that is distal from the anterior of the object.

Prism: As used in this disclosure, a prism is a three-dimensional geometric structure wherein: 1) the form factor of two faces of the prism are congruent; and, 2) the two congruent faces are parallel to each other. The two congruent faces are also commonly referred to as the ends of the prism. The surfaces that connect the two congruent faces are called the lateral faces. In this disclosure, when further description is required a prism will be named for the geometric or descriptive name of the form factor of the two congruent faces. If the form factor of the two corresponding faces has no clearly established or well-known geometric or descriptive name, the term irregular prism will be used. The center axis of a prism is defined as a line that joins the center point of the first congruent face of the prism to the center point of the second corresponding congruent face of the prism. The center axis of a prism is otherwise analogous to the center axis of a cylinder. A prism wherein the ends are circles is commonly referred to as a cylinder.

Sagittal Direction: As used in this disclosure, the sagittal direction runs from the superior surface to the inferior surface of an object and is perpendicular to the coronal direction and the transverse direction.

Sagittal Plane: As used in this disclosure, the sagittal plane refers to a reference plane that bisects a dexter surface and sinister surface such that the sagittal plane contains the line of the coronal direction and the line of the sagittal direction. The sagittal plane is perpendicular to the coronal plane and the transverse plane.

Scale: As used in this disclosure, a scale is an instrument used to measure the weight or mass of an object.

Seat: As used in this disclosure, a seat is a structure that a person can sit on. Chair is a common synonym for a seat.

Superior: As used in this disclosure, the term superior refers to a directional reference that is parallel to and in the opposite direction of the force of gravity when an object is positioned or used normally.

Supporting Surface: As used in this disclosure, a supporting surface is a horizontal surface upon which an object is placed and to which the load of the object is transferred. This disclosure assumes that an object placed on the supporting surface is in an orientation that is appropriate for the normal or anticipated use of the object.

Telescopic: As used in this disclosure, telescopic is an adjective that describes a composite prism structure made of hollow prism-shaped sections that fit or slide into each other such that the composite prism structure can be made longer or shorter by adjusting the relative positions of the hollow prism-shaped sections.

Transverse Direction: As used in this disclosure, the transverse direction runs from the anterior surface to the posterior surface of an object and is perpendicular to the coronal direction and the sagittal direction

Transverse Plane: As used in this disclosure, the transverse plane refers to a reference plane that bisects a superior surface and inferior surface such that the transverse plane contains the line of the transverse direction and the line of the transverse direction. The transverse plane is perpendicular to the coronal plane and the sagittal plane.

Vertical: As used in this disclosure, vertical refers to a direction that is either: 1) perpendicular to the horizontal direction; 2) parallel to the local force of gravity; or, 3) when referring to an individual object the direction from the designated top of the individual object to the designated bottom of the individual object. In cases where the appropriate definition or definitions are not obvious, the second option should be used in interpreting the specification. Unless specifically noted in this disclosure, the vertical direction is always perpendicular to the horizontal direction.

With respect to the above description, it is to be realized that the optimum dimensional relationship for the various components of the invention described above and in FIGS. 1 through 6 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A weighing chair comprising
a chair structure and a measurement structure;
wherein the measurement structure attaches to the chair structure;
wherein the weighing chair is a measurement device;
wherein the weighing chair is adapted for use with a patient;
wherein the weighing chair measures the weight of the patient as the patient is sitting in the weighing chair;
wherein the span of the length of the chair structure as measured parallel to the coronal direction is adjustable.

2. The weighing chair according to claim 1
wherein the chair structure is adapted for use by the patient;
wherein the patient sits in the chair structure;
wherein the measurement structure mounts in the chair structure;
wherein the measurement structure measures the weight of the patient while the patient sits in the chair structure;
wherein the span of the length of the chair structure in the coronal direction is adjustable.

3. The weighing chair according to claim 2 wherein the measurement structure is a measurement device;
wherein the measurement structure mounts in the chair structure;
wherein the measurement structure measures the weight of the patient as the patient sits in the chair structure;
wherein the measurement structure visibly displays the measured weight of the patient.

4. The weighing chair according to claim 3
wherein the chair structure comprises a bench, a backrest, and a plurality of armrests;
wherein the plurality of armrests attach to the bench and the backrest;
wherein the chair structure is further defined with a transverse direction, a coronal direction, and a sagittal direction;
wherein the transverse direction is the direction that runs from the posterior of the patient to the front of the patient when the patient is seated normally in the chair structure;
wherein the coronal direction is the direction that runs from the right side of the patient to the left side of the patient when the patient is seated normally in the chair structure;
wherein the coronal direction is perpendicular to the transverse direction;
wherein the sagittal direction is the direction that runs from the head of the patient towards the feet of the patient when the patient is seated normally in the chair structure;
wherein the sagittal direction is perpendicular to the transverse direction;
wherein the sagittal direction is perpendicular to the coronal direction.

5. The weighing chair according to claim 4
wherein the measurement structure comprises a sensing pad, a scale structure, and a scale stanchion;
wherein the sensing pad bears the load of the patient as the patient sits on the weighing chair;
wherein the sensing pad transfers an indication of the weight of the patient to the scale structure;
wherein the scale structure is a device;
wherein the scale structure receives the transferred indication of the weight of the patient;
wherein the scale structure converts the received indication of the weight of the patient into a visual indication of the measured weight of the patient;
wherein the scale stanchion is a hollow structure;
wherein the center axis of the scale stanchion is parallel to the sagittal direction;
wherein the hollow interior of the scale stanchion contains the scale structure;
wherein the visual indication of the weight of the patient is displayed such that the indication is visible from the exterior of the scale stanchion.

6. The weighing chair according to claim 5 wherein the bench is a horizontal surface formed by the chair structure;
wherein the bench forms a supporting platform that the patient sits on;
wherein the bench is a disk-shaped structure;
wherein the center axis of the bench is parallel to the sagittal direction;
wherein the bench attaches to the plurality of armrests such that the plurality of armrests elevates the bench above the surface supporting the weighing chair;
wherein the bench further comprises a bench superior face, a bench right lateral face, a bench left lateral face, a bench anterior lateral face, and a bench posterior lateral face;
wherein the bench superior face is a congruent end of the disk structure of the bench;
wherein the bench superior face forms the superior surface of the bench;
wherein the bench right lateral face is the lateral face of the disk structure of the bench that is on the right side of the patient when the patient is seated normally in the chair structure;
wherein the bench left lateral face is the lateral face of the disk structure of the bench that is on the left side of the patient when the patient is seated normally in the chair structure;
wherein the bench anterior lateral face is the lateral face of the disk structure of the bench that is on the anterior side of the patient when the patient is seated normally in the chair structure;
wherein the bench anterior lateral face is the lateral face of the disk structure of the bench that is on the posterior side of the patient when the patient is seated normally in the chair structure.

7. The weighing chair according to claim 6
wherein the center axis of the backrest is parallel to the coronal direction;
wherein the backrest forms a vertically oriented supporting structure that the patient can lean against;
wherein the backrest attaches to the plurality of armrests such that the plurality of armrests elevates the backrest above the surface supporting the weighing chair;
wherein the backrest further comprises a backrest anterior face, a backrest posterior face, a backrest right congruent end, and a backrest left congruent end;
wherein the backrest anterior face is the lateral face of the structure of the backrest that is proximal to the patient when the patient is seated normally in the chair structure;
wherein the backrest posterior face is the lateral face of the structure of the backrest that is distal from the patient when the patient is seated normally in the chair structure;
wherein the backrest right congruent end is the congruent end of the disk structure of the backrest that is on the right side of the patient when the patient is seated normally in the chair structure;
wherein the backrest left congruent end is the congruent end of the disk structure of the backrest that is on the left side of the patient when the patient is seated normally in the chair structure.

8. The weighing chair according to claim 7
wherein each of the plurality of armrests has a disk shape;
wherein each of the plurality of armrests is an irregular shape;
wherein the congruent ends of the disk structure of each of the plurality of armrests are perpendicular to the bench superior face;
wherein the plurality of armrests forms the load path that transfers the loads of the bench, the backrest, and the measurement structure to the surface supporting the weighing chair;
wherein the plurality of armrests elevates the bench and the backrest above the surface supporting the weighing chair.

9. The weighing chair according to claim 8
wherein the plurality of armrests attaches to the bench in a telescopic manner;
wherein the plurality of armrests attaches to the backrest in a telescopic manner;
wherein the telescopic structure of the plurality of armrests allows for the adjustment of the span of the distance between the plurality of armrests in the coronal direction;
wherein the adjustment of the span of the distance between the plurality of armrests in the plurality of armrests in the coronal direction adjusts the form factor of the chair structure.

10. The weighing chair according to claim 9
wherein the plurality of armrests further comprises a right armrest and a left armrest;
wherein the right armrest is the armrest selected from the plurality of armrests that supports the bench and the backrest from the right side of the patient when the patient is seated normally in the chair structure;
wherein the right armrest attaches to the bench right lateral face;
wherein the right armrest attaches to the backrest right congruent end;
wherein the right armrest further comprises a right armrest interior face;
wherein the right armrest interior face is the congruent end of the irregular disk structure of the right armrest that is proximal to the patient when the patient is seated normally in the chair structure;
wherein the left armrest is the armrest selected from the plurality of armrests that supports the bench and the backrest from the left side of the patient when the patient is seated normally in the chair structure;
wherein the left armrest attaches to the bench left lateral face;
wherein the left armrest attaches to the backrest left congruent end;
wherein the left armrest is identical to the right armrest;
wherein the left armrest further comprises a left armrest interior face;
wherein the left armrest interior face is the congruent end of the irregular disk structure of the left armrest that is proximal to the patient when the patient is seated normally in the chair structure.

11. The weighing chair according to claim 10
wherein the bench further comprises a first plurality of mortises;
wherein the first plurality of mortises attach the bench to the plurality of armrests;
wherein each of the first plurality of mortises is a mortise that is formed in the bench;
wherein the backrest further comprises a second plurality of mortises;
wherein the second plurality of mortises attach the backrest to the plurality of armrests;
wherein each of the first plurality of mortises is formed as a negative space;
wherein each of the first plurality of mortises is formed in a lateral face selected from the group consisting of the bench right lateral face and the bench left lateral face;
wherein each of the second plurality of mortises is a mortise that is formed in the backrest;
wherein each of the second plurality of mortises is formed as a negative space;
wherein each of the second plurality of mortises is formed in a congruent end selected from the group consisting of the backrest right congruent end and the backrest left congruent end;
wherein the right armrest further comprises a first plurality of tenons;
wherein the first plurality of tenons attach the right armrest to the bench and the backrest;
wherein each of the first plurality of tenons is a tenon;
wherein the left armrest further comprises a second plurality of tenons;
wherein the second plurality of tenons attach the left armrest to the bench and the backrest;
wherein the second plurality of tenons is a tenon.

12. The weighing chair according to claim 11
wherein each of the first plurality of mortises receives a tenon selected from the group consisting of: a) a tenon contained in the first plurality of tenons; and, b) a tenon contained in the second plurality of tenons;
wherein the received selected tenon attaches the bench to the plurality of armrests;
wherein each of the second plurality of mortises receives a tenon selected from the group consisting of: a) a tenon contained in the first plurality of tenons; and, b) a tenon contained in the second plurality of tenons;
wherein the received selected tenon attaches the backrest to the plurality of armrests.

13. The weighing chair according to claim 12
wherein each of the first plurality of tenons is geometrically similar to a mortise selected from the group consisting of: a) a mortise contained in the first plurality of mortises; and, b) a mortise contained in the second plurality of mortises;
wherein each tenon selected from the first plurality of tenons is sized such that the selected tenon will insert into the selected mortise;
wherein each tenon selected from the first plurality of tenons attaches to an interior face selected from the group consisting of: a) the right armrest interior face; and, b) the left armrest interior face;
wherein each tenon selected from the first plurality of tenons attaches to the associated selected interior face such that the center axis of the selected tenon projects perpendicularly away from the associated selected interior face;
wherein each of the second plurality of tenons is geometrically similar to a mortise selected from the group consisting of: a) a mortise contained in the first plurality of mortises; and, b) a mortise contained in the second plurality of mortises;
wherein each tenon selected from the second plurality of tenons is sized such that the selected tenon will insert into the selected mortise;
wherein each tenon selected from the second plurality of tenons attaches to an interior face selected from the group consisting of: a) the right armrest interior face; and, b) the left armrest interior face;
wherein each tenon selected from the second plurality of tenons attaches to the associated selected interior face such that the center axis of the selected tenon projects perpendicularly away from the associated selected interior face.

14. The weighing chair according to claim 13
wherein the sensing pad is a mechanical structure;
wherein the sensing pad is a disk-shaped structure;
wherein the sensing pad attaches to the bench superior face to form a composite structure;
wherein the transferred indication of the weight of the patient is selected from the group consisting of: a) the load presented by the patient to the sensing pad; or b) a measured value that indicates to the scale structure the weight of the patient.

15. The weighing chair according to claim 14
wherein the scale stanchion further comprises a scale stanchion anterior face;
wherein the scale stanchion anterior face is the lateral face of the scale stanchion that is proximal to the posterior surfaces of the patient as the patient sits normally in the chair structure;
wherein the scale stanchion anterior face attaches to the bench posterior lateral face;
wherein the scale stanchion anterior face attaches to the backrest posterior face;
wherein the visual indication of the weight of the scale stanchion anterior face is visible from the scale stanchion anterior face.

16. The weighing chair according to claim 15
wherein the scale structure is selected from the group consisting of a balance scale and a force sensor scale;
wherein the balance scale is a mechanical structure;
wherein the full weight of the patient is transferred to the scale structure where it is received as a load;
wherein the balance scale comprises a plurality of masses that are used to generate a calibrated counter force;
wherein the balance scale measures the difference between the weight of the patient and the calibrated counter force generated by the scale structure;
wherein the balance scale displays the weight of the patient by displaying the calibrated counterforce when the difference between the weight of the patient and the calibrated counter force equals zero;
wherein the force sensor scale is an electromechanical device;
wherein the force sensor scale measures the weight of the patient using a piezoelectric device;
wherein the piezoelectric sensor uses the piezoelectric effect to generate a voltage that is converted by an electric circuit into a visual display of the weight of the patient.

17. The weighing chair according to claim 16
wherein the first plurality of mortises comprises a first mortise, a second mortise, a third mortise, and a fourth mortise;
wherein the first mortise is a mortise that is formed in the bench right lateral face;
wherein the first mortise is in an anterior position relative to the second mortise;
wherein the second mortise is a mortise that is formed in the bench right lateral face;
wherein the second mortise is in a posterior position relative to the first mortise;
wherein the third mortise is a mortise that is formed in the bench left lateral face;
wherein the third mortise is in an anterior position relative to the fourth mortise;
wherein the fourth mortise is a mortise that is formed in the bench left lateral face;
wherein the fourth mortise is in a posterior position relative to the third mortise.

18. The weighing chair according to claim 17
wherein the second plurality of mortises comprises a fifth mortise and a sixth mortise;
wherein the fifth mortise is a mortise that is formed in the backrest right congruent end;
wherein the center axis of the fifth mortise aligns with the center axis of the backrest;
wherein the sixth mortise is a mortise that is formed in the backrest left congruent end;
wherein the center axis of the sixth mortise aligns with the center axis of the backrest.

19. The weighing chair according to claim 18
wherein the first plurality of tenons comprises a first tenon, a second tenon, and a third tenon;
wherein the first tenon is a tenon that attaches to the right armrest interior face;
wherein the first tenon is geometrically similar to the first mortise;
wherein the first tenon is sized such that the first tenon inserts into the first mortise to secure the right armrest interior face to the bench right lateral face;
wherein the span of the distance between the right armrest and the left armrest adjusts by adjusting the depth that the first tenon into the first mortise;
wherein the second tenon is a tenon that attaches to the right armrest interior face;
wherein the second tenon is geometrically similar to the second mortise;
wherein the second tenon is sized such that the second tenon inserts into the second mortise to secure the right armrest interior face to the bench right lateral face;
wherein the span of the distance between the right armrest and the left armrest adjusts by adjusting the depth that the second tenon into the second mortise;
wherein the third tenon is a tenon that attaches to the right armrest interior face;
wherein the third tenon is geometrically similar to the third mortise;
wherein the third tenon is sized such that the third tenon inserts into the third mortise to secure the right armrest interior face to the backrest right congruent end;
wherein the span of the distance between the right armrest and the left armrest adjusts by adjusting the depth that the third tenon into the third mortise.

20. The weighing chair according to claim 19
wherein the second plurality of tenons comprises a fourth tenon, a fifth tenon, and a sixth tenon;
wherein the fourth tenon is a tenon that attaches to the left armrest interior face;
wherein the fourth tenon is geometrically similar to the fourth mortise;
wherein the fourth tenon is sized such that the fourth tenon inserts into the fourth mortise to secure the left armrest interior face to the bench left lateral face;
wherein the span of the distance between the right armrest and the left armrest adjusts by adjusting the depth that the fourth tenon into the fourth mortise;
wherein the fifth tenon is a tenon that attaches to the left armrest interior face;
wherein the fifth tenon is geometrically similar to the fifth mortise;
wherein the fifth tenon is sized such that the fifth tenon inserts into the fifth mortise to secure the left armrest interior face to the bench left lateral face;
wherein the span of the distance between the right armrest and the left armrest adjusts by adjusting the depth that the fifth tenon into the fifth mortise;
wherein the sixth tenon is a tenon that attaches to the left armrest interior face;
wherein the sixth tenon is geometrically similar to the sixth mortise;
wherein the sixth tenon is sized such that the sixth tenon inserts into the sixth mortise to secure the left armrest interior face to the backrest left congruent end;
wherein the span of the distance between the right armrest and the left armrest adjusts by adjusting the depth that the sixth tenon into the sixth mortise.
